(19) United States
(12) Patent Application Publication
(10) Pub. No.: US 2002/0159482 A1
(43) Pub. Date: Oct. 31, 2002

(54) Data transmission method and system

(76) Inventors: Martin Hans, Hildesheim (DE); Norbert Kroth, Potsdam (DE)

Correspondence Address: BELL, BOYD & LLOYD, LLC, P. O. BOX 1135, CHICAGO, IL, 60690-1135, US

(21) Appl. No.: 10/078,578

(22) Filed: Feb. 19, 2002

(30) Foreign Application Priority Data
Feb. 20, 2001 (DE) 101 08 146.4

(51) Int. Cl. H04L 12/28; H04J 1/02; H04J 3/24; H04B 7/24

(52) U.S. Cl. 370/493; 370/473; 370/312; 455/39

(57) ABSTRACT

A data transmission method and system, wherein a transmitter unit adds a sequence number, which represents the transmission sequence of the transmission data packets to each of the transmission data packets to be transmitted before the transmission of data via a data transmission link. A receiver unit evaluates the respective sequence number of the transmission data packets after their reception. By comparing the sequence number of the respectively newly received transmission data packet with the sequence numbers of previously received transmission data packets, it is determined whether transmission data packets which lie before the respectively received transmission data packet in the transmission sequence have not yet been received and processed. These transmission data packets are then marked as temporarily missing and made available with this marking for further evaluation.

### BACKGROUND OF THE INVENTION

The present invention relates to a data transmission method, a sequence number, which represents the transmission sequence of the transmission data packets, being added to each of the transmission data packets to be transmitted, via at least one transmitter unit before the transmission of data via a data transmission link and the respective sequence number of the transmission data packets being evaluated via at least one receiver unit after reception of the transmission data packets.

The present invention is directed toward finding a way of reliably making available for evaluation at the receive end data packets which are to be transmitted successively despite any interchanging of sequences or losses during their transmission.

### SUMMARY OF THE INVENTION

This object is achieved with a method of the type mentioned at the beginning by virtue of the fact that, in the receiver unit, it is determined, by comparing the sequence number of the respectively newly received transmission data packet with the sequence numbers of previously received transmission data packets, whether transmission data packets which lie before the respectively received transmission data packet in the transmission sequence have not yet been received and processed, and by virtue of the fact that these transmission data packets are marked as temporarily missing and made available for evaluation.

This receive-end classification of the transmitted transmission data packets improves the regeneration of the data packets which are dispatched at the transmit end.

Additional features and advantages of the present invention are described in, and will be apparent from, the following Detailed Description of the Invention and the Figures.

### BRIEF DESCRIPTION OF THE FIGURES

FIG. 1 shows a schematic view of the transmit-side assignment and distribution of 4 data packets to be transmitted between three transmission data packets which are transmitted from a transmitter unit to a receiver unit over the actual transmission channel.

FIG. 2 is a schematic view of a modified parameter message between a mobile telephone unit and a superordinate network unit for carrying out the inventive, receive-end assignment method of received transmission data packets and transmission data packets which are still missing to the original data packets which are dispatched at the transmit end.

FIG. 3 is a schematic view of the radio interface between a mobile telephone unit of a radiocommunication system and a superordinate radio network unit between which data packets are exchanged according to the inventive method using the parameter message according to FIG. 3.

FIG. 4 is a schematic view of the basic structure of the network components of a radiocommunications system for carrying out the method according to the present invention.

### DETAILED DESCRIPTION OF THE INVENTION

The document 3GPP TS 25.322 “RLC Protocol Specification” (in particular, section 11.2 “Unacknowledged mode data transfer procedure”) discloses a method which makes it simple to adapt data packets of any desired size in a transmitter device into data packets of a size which is optimized for the mobile telephone system radio interface which is used, and to transmit them in such a way that the original data packets can be recovered from the transmission data packets in a receiver device.

If the part of the transmission data packet which is used for the transmission of a data packet is smaller here than the size of the data packet, the data packet is segmented in such a way that the segment which is produced in the process fills the transmission data packet in an optimum way. If appropriate, control data are added to the control data header of the transmission data packet in order to allow the user to perform correct desegmentation.

If the part of the transmission data packet which is used for transmission of a data packet is larger than the size of the data packet, the data packet does not fill the transmission data packet. Moreover, control data, which signal to the receiver that one data packet ends and, if appropriate, a further data packet starts in the same transmission data packet, is expediently added to a control data header.

In this way, data packets of any desired size are distributed between transmission data packets of a specific size.

For correct reception and correct recovery of a data packet it is expedient to transmit all the transmission data packets which contain segments of a specific data packet and to retain the sequence in which the transmission data packets are transmitted from the transmitter to the receiver. In order to permit the receiver to detect the absence of a transmission data packet, a sequence number (SN) is therefore added to the control data header of the transmission data packets in the transmitter unit. All the transmission data packets which are dispatched are consecutively numbered using this sequence number, and by checking this uniquely assigned sequence number, the receiver can detect whether all the transmission data packets have actually been received.

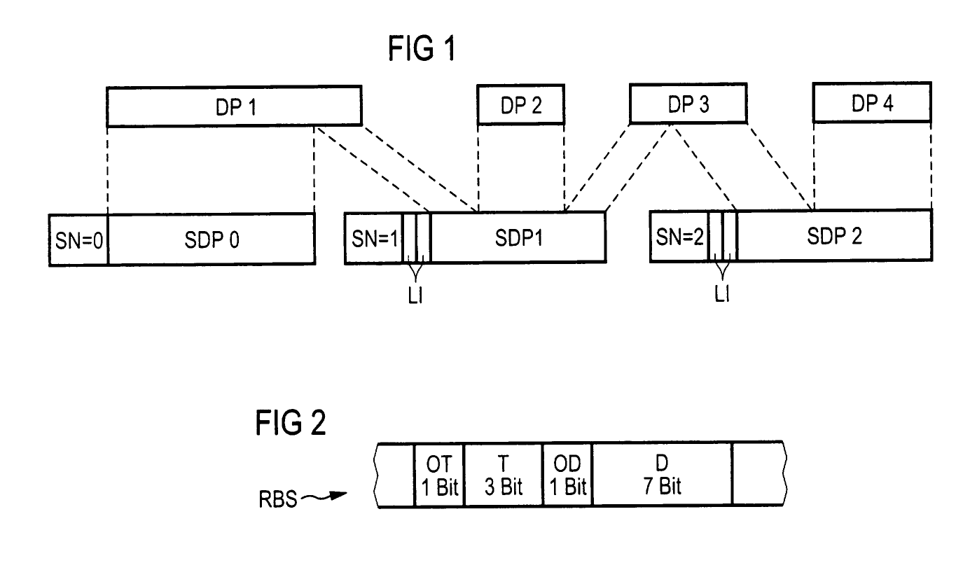

FIG. 1 illustrates an example in which four data packets DP1 DP2, DP3, DP4 are transmitted in three transmission data packets SDP0, SDP1, SDP2, each transmission data packet containing a uniquely assigned sequence number SN=0, SN=1, SN=2, and each end of a data packet which ends in a transmission data packet being identified by at least one length indicator LI. The interrupted lines in FIG. 1 characterize the association between the data from the individual data packets DP1 with DP4 and the corresponding data in the transmission data packets SDP0, SDP1, SDP2. In particular, in this exemplary embodiment the data packet DP1 which is to be transmitted is assigned to the two transmission data packets SDP0 and SDP1; i.e., distributed between two transmission data packets. The data packet DP2 which is to be transmitted fills the transmission data packet SDP1 only partially; for this reason, part of the following third data packet DP3 can also be packed into the transmission data packet SDP1, while its remainder is transmitted in a third transmission data packet SDP2. The fourth data packet DP4 to be transmitted is finally also accommodated in the third transmission data packet SDP2.

If the respective receiver unit detects the absence of a transmission data packet, it rejects all the data packets whose segments could be contained in the missing transmission data packet. As such, means for the example described above, if the absence of, for example, the transmission data packet SDP1 is detected by the respective receiver unit, the data packets DP1, DP2 and DP3 have not been correctly received and the restoration of the data packets is not pursued. The data packets are, therefore, rejected.

Moreover, with mobile telephone transmission methods and in other transmission systems the sequence in which transmission data packets have been dispatched by the respective transmitter unit may not be retained. As such, transmission data packets arrive at the receiver unit in a sequence which is different from the original transmission sequence. In combination with the data segmentation and transmission method described above, the following problems, in particular, occur:

If the sequence of packets is interchanged during the transmission, transmission data packets with a relatively high sequence number (SN) inevitably arrive earlier in the respective receiver unit than those packets with a relatively low sequence number. However, the reception of packets with a higher sequence number than the expected one expediently leads to data packets being rejected and not restored. In the above-mentioned example, the reception of the transmission data packet SDP2 directly after the transmission data packet SDP0 (omitting SDP1) would lead to a situation in which the data packets DP1, DP2 and DP3 could not be restored correctly even if the transmission data packet SDP1 were received subsequently; i.e., only later after the transmission data packet SDP2. Merely performing simple buffering of transmission data packets received in the incorrect sequence and waiting for the missing data packets would not be expedient here, and would be impossible in practice because it would be perfectly possible that transmission data packets would not be transmitted or would be transmitted incorrectly and therefore would not be received at all in the respective receiver unit, which would lead to an eternal waiting state and would block the transmitter/receiver system indefinitely.

A further problem which occurs when the sequence of transmission data packets is interchanged is associated with the limited value range of the sequence number: the sequence number SN is represented in the control data header of the respective transmission data packet by a specific number of bits and is, as a result, restricted in its value range (in the example mentioned above, the value range 0 . . . 127 is represented by 7 bits, for example). After the maximum value is reached, the counting expediently continues at zero (what is referred to as modulo counting).

A receiver unit which does not have the inventive modification of the data transmission method and which waits for transmission data packets in the correct sequence would, given reception of a transmission data packet with a sequence number which is not in the expected sequence, detect all the transmission data packets between the expected sequence number and the received sequence number as being missing and reject the corresponding data packets. With respect to subsequently received transmission packets which were transmitted earlier, the receiver unit would not be able to decide whether the respectively received transmission data packet is actually a transmission data packet which was dispatched earlier or a transmission data packet which was dispatched later. In the example mentioned above (transmission sequence: SDP0, SDP1, SDP2; reception sequence: SDP0, SDP2, SDP1), the receiver unit can, after the reception of SDP1, not decide whether the transmission data packet is the transmission data packet (SN=1) which was previously detected as missing or whether it is a transmission data packet which was dispatched 127 transmission data packets after SDP2 (and which would also bear the sequence number SN=1 owing to the modulo counting). In this case, all 127 data packets would be detected as being missing and data packets which have not yet been completely assembled from transmission data packets which already have been received would be rejected without reason.

In order to be able to reliably make available for evaluation at the receive end data packets which are to be transmitted successively despite any interchanging of sequences or losses during their transmission, the data transmission is advantageously carried out as follows:

Using the sequence number in the control data header of received transmission data packets, the respective receiver unit marks as temporarily missing transmission data packets which have not been received and whose sequence number shows them to be transmission data packets before the received transmission data packets in the transmission sequence. It then postpones the processing of received transmission data packets, carries out buffering of the transmission data packets and resumes processing them again only when all the transmission data packets which were originally marked as temporarily missing have been either marked as definitely missing or marked as received and processed. Here, transmission data packets which are marked as temporarily missing are

a) marked as definitely missing if their sequence number exceeds a specific maximum difference D (see FIGS. 2, 4) with respect to the sequence number of the transmission data packet which was received last and previously was not marked as temporarily missing or if they were marked as temporarily missing for a specific maximum missing time T, in particular what is referred to as modulo counting is implemented here for calculating the difference of D; or

b) marked as received if condition a) is not met and transmission data packets are received whose sequence number corresponds to the transmission data packets previously marked as missing.

This data transmission method has the particular advantage that even when transmission data packets are received in a sequence which is different from the transmission sequence no receive data are rejected unnecessarily, which considerably increases the data throughput rate and the error rate of the data transmission.

A further advantage of this data transmission principle is that the suspension of the reception of transmission data packets does not have a permanently negative effect on the data transmission because the processing of transmission data packets which already have been received is continued either with controlled timing or by comparing sequence numbers.

A further advantage can lie, in particular, in the parameters D and T which can be set in a variable fashion by a superordinate unit with the result that the method described here can be adjusted individually to the conditions of the transmission channel used.

A further advantage is, if appropriate, that the receiver unit interprets all received transmission data packets with a sequence number which does not exceed the maximum difference D with respect to the sequence number of the transmission data packet which was received last and previously not marked as temporarily missing as being the missing transmission data packets. A uniquely defined separation between sequence numbers of missing transmission data packets and sequence numbers of newly received transmission data packets is therefore defined, with the result that the interpretation problems of sequence numbers which occur as a result of modulo counting are overcome.

It may be particularly expedient to transmit the parameter D and/or T from the respective transmitter unit to the respective receiver unit before or during the actual data transmission. It may, under certain circumstances, be advantageous to determine both parameters D and T of a unit which is superordinate to the data transmission and to transmit them to the receiver unit in a configuration message before or during the setting up of the data transmission link. It is also possible here to define the setting of the parameters in the receiver as a preset value by failing to transmit the parameters in the configuration message.

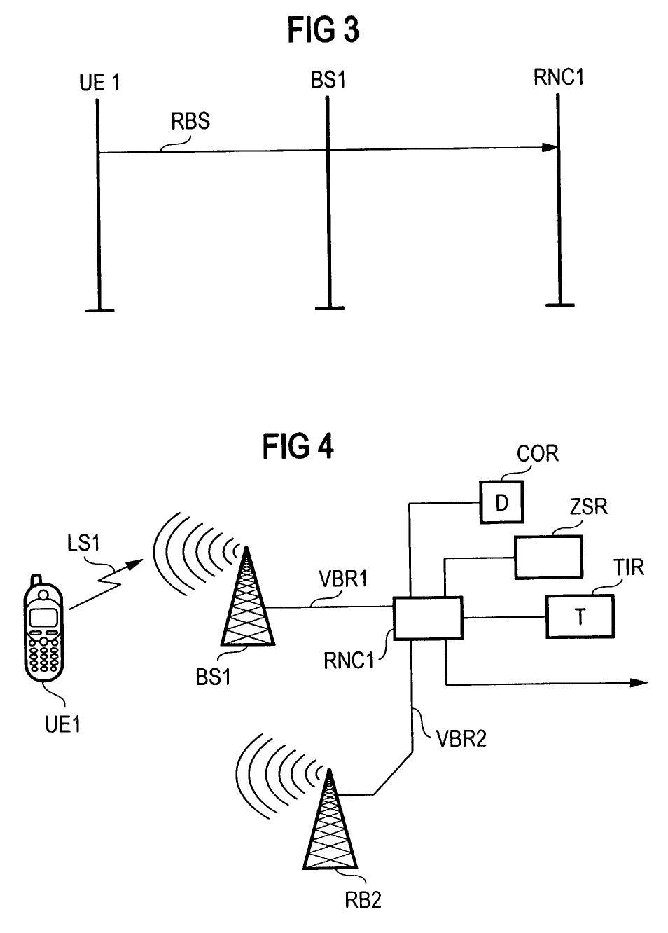

A mobile telephone network according to the mobile telephone standard UMTS (universal mobile telecommunication system), in which, for example a mobile station UE1 (cf. FIGS. 3, 4) constitutes the receiver unit and what is referred to as a radio network controller RNC1 as a further radio network component constitutes the transmitter unit and the superordinate unit, is considered by way of example below. The reception method which is improved in this invention is described, in particular, in 3GPP TS 25.322 “RLC Protocol Specification” (in particular section 11.2 “Unacknowledged mode data transfer procedure”).

When a data transmission link is set up, a parameter message RBS (=RADIO BEARER SETUP) is transmitted by the superordinate network unit RNC1 to the mobile telephone unit UE1 via the radio interface LS1 of a respective base station BS1 in which various parameters of the data transmission are transferred. The base station BS1 is controlled here from the superordinate radio network unit RNC1 and is operatively connected to it via a fixed link VBR1, for example. Here, of course, further base stations also may be assigned to the radio network control unit RNC1 in order to administer their radio resources in associated radio cells. This is illustrated by way of example in FIG. 4 by the fact that a second base station BS2 is coupled to the same radio network control unit RNC1 as the base station BS1 via a fixed link VBR2. The parameter message RBS is then expediently supplemented with the parameters D and T. Here, the parameter D has a value range from 0 to 127 and is represented by a 7-bit long, binary-coded field within the message. The parameter T can assume the values 10 ms, 20 ms, 30 ms, 40 ms, 50 ms, 60 ms, 70 ms, 80 ms and is coded by a three-bit long field whose bit combinations are assigned to the parameter values as follows, for example:

| | | | | | | | | |
|---|---|---|---|---|---|---|---|---|
| Parameter | 10 | 20 | 30 | 40 | 50 | 60 | 70 | 80 |
| value | ms | ms | ms | ms | ms | ms | ms | ms |
| Bit | 0 0 0 | 0 0 1 | 0 1 0 | 0 1 1 | 1 0 0 | 1 0 1 | 1 1 0 | 1 1 1 |
| combination | | | | | | | | |

The simultaneous existence of both parameters D and T in the same parameter message is preferably optional. For this reason, the parameters are each preceded by a selection parameter (OT and OD) which indicates whether the parameter (corresponding to T or D) is present. This additional selection parameter is preferably encoded with a bit. Here, the bit value OT=0 (or OD=1) indicates that the parameter T (or D) is present, the bit value OT=0 (or OD=0) indicates that the parameter is not present, and the value for T (or D) assumes a preset value such as 0 ms (or D=64). The RADIO BEARER SETUP message RBS which is expanded in this way is shown schematically in FIG. 2.

In order to store the parameters D and T, the reception unit of the radio network control unit RNC1 is advantageously assigned corresponding buffers or memories COR (=Counter), TIR (=Timer), which is illustrated schematically in FIG. 4.

In this specific exemplary embodiment, the parameters will be assumed to be T =60 ms and D=4.

After the data transmission link is set up, the data transmission starts and 12 transmission data packets SDP 0 to SDP 12 with the corresponding sequence numbers 0 to 12 are transmitted by the transmitter unit.

At the receiver unit, transmission data packets SDP1 with SDP12, for example, are received in the following sequence, in which case there is preferably to be a period of not longer than 10 ms between the reception of the various transmission data packets in the exemplary embodiment here:

SDP0, SDP1, SDP4, SDP5, SDP2, SDP3, SDP6, SDP8, SDP9, SDP10, SDP12, while SDP7 and SDP11 are not to be transmitted at all as a result of a transmission error.

According to the present invention, the receiver then proceeds for the present exemplary embodiment as follows:

SDP0 and SDP1 are received and, because no missing transmission data packets are detected using their respective sequence number SN=0, 1, they are also processed in accordance with their original sequence.

SDP 4 and SDP 5 are received as the next transmission data packets; the transmission data packets SDP2 and SDP3 are detected as being temporarily missing using their sequence numbers SN and marked. The transmission data packets SDP4 and SDP5 are subsequently not processed but rather buffered. The buffering preferably can take place here in a specially reserved buffer, for example ZSR in the receiver unit of the radio network control unit (see FIG. 4).

The transmission data packets SDP 2 and SDP 3 are only received after it, and it is determined that their sequence numbers SN show them to be the transmission data packets marked as temporarily missing. SDP 2 and SDP 3 are then marked as received and processed. The buffered transmission data packets SDP4 and SDP5 then are also processed and deleted from the buffer ZSR.

Finally, the transmission data packet SDP6 is received and because no missing transmission data packets are detected using its sequence number SN, it is processed.

The transmission data packets SDP8, SDP9 and SDP10 are then received and the transmission data packet SDP7 is detected as being temporarily missing using their assigned sequence numbers SN, and marked. The transmission data packets SDP8, SDP9 and SDP10 are then buffered, for example in the buffer ZSR, and not yet processed.

Finally, the transmission data packet SDP 12 is received. The transmission data packet SDP7 is marked as definitely missing on the basis of the difference between its sequence number SN=7 and the sequence number SN=12, now received, of the transmission data packet SDP12, which exceeds the set parameter D=4, and the buffered transmission data packets SDP8, SDP9 and SDP10 are processed and deleted from the buffer ZSR. The transmission data packet SDP11 is marked as temporarily missing and the received transmission data packet SDP12 is buffered.

No further transmission data packet is received after the transmission data packet SDP12. 60 ms after the reception of SDP12, the SDP11 is marked as definitely missing because the time period in which it was marked as temporarily missing reaches the set parameter T=60 ms. The transmission data packet SDP12 is then processed and deleted from the buffer ZSR.

In this way, it is advantageously ensured here that the transmission data packets SDP1, SDP2, SDP3, SDP4, SDP5, SDP6, and SDP8, SDP9, SDP10 are processed in the original transmission sequence and for this reason all the data packets contained completely in them can be restored and further processed by superordinate units without the reception being permanently disrupted as a result of the suspension of the reception of the transmission data packets SDP7 and SDP11.

The sum of two numbers A and B is introduced below in modulo calculation (for example, modulo 128) as follows:

Sum=(A+B)mod128.

Examples:

(100+27)=127

(100+28)=0

(100+29)=1

(13+127)=12

The difference between two numbers A and B in modulo calculation is then calculated (for example, for modulo 128) as follows:

Difference=(A−B+128)mod 128.

Examples:

127−28=99

28−127=29

X mod Y designates the remainder of the integral division of X by Y. Here, X=(A+B) and Y=128.

In the present exemplary embodiment, the modulo calculation is trivial:

When the transmission data packets SDP2 and SDP3 are received, their sequence numbers SN=2,3 are compared with the sequence number SN=5 of the transmission data packet SDP5 (last received sequence number and sequence number which is not yet marked as missing); the result of the modulo difference formation 5−2=3 or 5−3=2 therefore remains below the predefined maximum D=4.

When the transmission data packet SDP12 is received, the difference between its sequence number SN=12 and the sequence number SN=7 of the transmission data packet SDP7 is formed; the modulo difference 12−7=5 exceeds D=4. The transmission data packet SDP7 is thus marked as definitely missing.

Less trivial examples occur only if there were already more than 128 transmission data packets SDPi, where i>128, during the transmission. If, for example, the last, non-missing transmission data packet then bears, for example, the sequence number SN=3 and a transmission data packet with the sequence number SN=126 is missing, the difference between 3 and 126 according to the modulo calculation rule above is as follows: 3−126+128=5. The transmission data packets with the sequence number SN=126 therefore would be characterized as definitely missing on the basis of the comparison with D=4.

Considered in general terms, the data exchange according to the present invention of a fixed sequence of data between the transmitter unit of at least one first component of a radiocommunication system and a receiver unit of at least one second component can thus take place. In particular, the respective radiocommunication system has at least one transmitter unit and/or receiver unit, designed for data exchange, in at least one mobile telephone unit and at least one further radio network component such as, for example, a further mobile telephone unit, base station, radio network control unit or the like. In particular, the respective transmitter/receiver unit can be implemented here via hardware and/or by software applications.

According to the inventive data transmission method, the transmission data packets can be transmitted between at least one transmitter unit and at least one receiver unit, preferably in a GSM (global system for mobile communications), GPRS (general radio packet service), EDGE (enhanced data rates for GSM evolution) or UMTS (universal mobile telecommunication system) radiocommunication system.

The data exchange method according to the present invention is suitable, in particular, for transmission interfaces between at least one transmitter unit and at least one receiver unit via which there is no acknowledgement of received data packets from the receiver unit to the transmitter unit, as, for example, in the unacknowledged mode of UMTS.

Although the present invention has been described with reference to specific embodiments, those of skill in the art will recognize that changes may be made thereto without departing from the spirit and scope of the invention as set forth in the hereafter appended claims.

1. A data transmission method, the method comprising the steps of:
adding a sequence number, which represents a transmission sequence of transmission data packets, to each of the transmission data packets to be transmitted, via at least one transmitter unit before the transmission of data via a data transmission link;
evaluating the respective sequence number of the transmission data packets via at least one receiver unit after reception of the transmission data packets;
determining, in the receiver unit by comparing the sequence number of the respectively received transmission data packet with the sequence numbers of previously received transmission data packets, whether transmission data packets which lie before the respectively received transmission data packet in the transmission data sequence have not yet been received and processed; and
marking as temporarily missing, and making available for evaluation, the transmission data packets which have not yet been received and processed.

2. A data transmission method as claimed in claim 1, the method further comprising the step of adding a sequence number, in a control data header, to each of the transmission data packets to be transmitted, via the transmitter unit before the transmission of data via the data transmission link.

3. A data transmission method as claimed in claim 1, the method further comprising the step of postponing processing of the received transmission data packets until all transmission data packets which lie before the respectively received transmission data packet in the transmission sequence have been one of received and processed, and marked as definitely missing.

4. A data transmission method as claimed in claim 3, wherein a transmission data packet is marked as definitely missing if the sequence number assigned to it exceeds a maximum difference with respect to the sequence number of the transmission data packet which was received last and has not yet been marked as one of temporarily and definitely missing before the reception.

5. A data transmission method as claimed in claim 4, wherein a modulo calculation is used as a basis for the difference calculation.

6. A data transmission method as claimed in claim 3, wherein a transmission data packet is marked as definitely missing if the transmission data packet which is respectively expected at the receiver unit has been marked as temporarily missing for a specific time.

7. A data transmission method as claimed in claim 4, wherein parameters for the difference are transmitted to the receiver unit by a unit which is superordinate to the data transmission at a time which is one of before set up and during set up of the data transmission link.

8. A data transmission method as claimed in claim 4, wherein parameters for the specific time are transmitted to the receiver unit by a unit which is superordinate to the data transmission at a time which is one of before set up and during set up of the data transmission link.

9. A data transmission method as claimed in claim 1, wherein the transmission data packets are transmitted between at least one transmitter unit and at least one receiver unit in one of a GSM, a GPRS, an EDGE, and a UMTS radio communication system.

10. A radiocommunication system comprising at least one transmitter unit and at least one receiver unit, wherein a sequence number, which represents a transmission sequence of transmission data packets, is added to each of the transmission packets via the at least one transmitter unit before the transmission of data via a data transmission link, the respective sequence number of the transmission data packet is evaluated via the at least one receiver unit after reception of the data transmission packets, and wherein it is determined, in the at least one receiver unit, by comparing the sequence number of the respectively received transmission data packet with the sequence numbers of previously received data transmission packets, whether transmission data packets which lie before the respectively received transmission data packet in the transmission data sequence have not yet been received and processed, and the transmission data packets which have not yet been received and processed are marked as temporarily missing and made available for evaluation.
